(19) United States
(12) Patent Application Publication
(10) Pub. No.: US 2025/0281838 A1
(43) Pub. Date: Sep. 11, 2025

(54) Community Game Help

(71) Applicant: Sony Interactive Entertainment Inc., Tokyo (JP)

(72) Inventors: Christopher Fife, San Mateo, CA (US); Dustin Clingman, San Mateo, CA (US); Michael Rich, San Mateo, CA (US); Ramana Prakash, San Mateo, CA (US); Dmitry Makarov, San Mateo, CA (US); Masahiro Fujihara, San Mateo, CA (US); Toshihiko Nagasawa, San Mateo, CA (US)

(21) Appl. No.: 18/635,959

(22) Filed: Apr. 15, 2024

Related U.S. Application Data
(60) Provisional application No. 63/563,850, filed on Mar. 11, 2024.

(51) Int. Cl. A63F 13/5375; A63F 13/63; A63F 13/86

(52) U.S. Cl. CPC A63F 13/5375; A63F 13/63; A63F 13/86

(57) ABSTRACT

Video and image content is captured from gamers according to certain rules to generate videos for computer game help. Also, video and image content are captured for crash reporting and correction. Player videos are thus leveraged to provide customized help content for video games, and rules are provided to determine the “best” video to provide help.

### FIELD

The present application relates generally to community game help.

### BACKGROUND

Producing computerized help utilities for computer games typically is a time-consuming manual chore requiring intense collaboration with game developers, often needing months of lead time prior to game launch. Despite this collaboration and oversight, it remains difficult to provide complete game help coverage on launch day, and often help is not available for weeks after launch. In addition, game developers may refuse to support generating a help utility and so some games end up with no help utility at all.

### SUMMARY

Present principles, in recognizing the above technical challenges, provide techniques to generate game help videos at scale that are representative of normal gameplay, fully demonstrate how to complete a particular part of the game, and can be generated from organic community gameplay.

Accordingly, a method includes determining that respective plural signals from respective plural computer game consoles indicate respective opt-ins to upload game videos for generating game help. The method also includes, responsive to the opt-ins, determining whether new help submissions are still being accepted for a first computer game activity, and responsive to new help submissions still being accepted for the first computer game activity, determining, for each of respective video clips pertaining to the first computer game activity and uploaded from the respective computer game consoles, whether the video clip qualifies as a help clip based at least in part on at least one time period associated with the video clip. The method further includes downloading at least one of the respective video clips pertaining to the first computer game activity and determined to qualify as a help clip to at least one computer game console other than the plural computer game consoles.

In examples, the respective video clips include metadata associating respective times with respective game events. The metadata can include an identification of a game associated with the video clip and an identification of an activity captured by the video clip.

In some implementations the method may include determining whether a video clip qualifies as a help clip at least in part by determining whether a time period to complete a first computer game activity in the video clip has a relationship to play time periods from a community of players. In specific embodiments this may include determining completion time periods for the first computer game activity from plural players, determining completion percentiles using the completion time periods, and determining that a video clip qualifies as a help clip based on the time period to complete the first computer game activity in the video clip is within a window of completion time periods.

In an example embodiment determining whether new help submissions are still being accepted for the first computer game activity can include determining whether a predetermined maximum number of help clips are identified for the first game activity.

In a non-limiting implementation the first video game activity includes discovering an in-game item, and the method includes identifying an end time based on when the item was discovered. The method also may include identifying a start time using a default look back period from the end time, and generating the video clip as a help clip using video from the start time to the end time.

In another aspect, a processor system is configured to receive at least first and second video clips from respective first and second end user computer game consoles, with each video clip representing a first in-game activity for a first computer game. The processor system also is configured to provide the first and second video clips to at least a third end user computer game console as help videos.

In another aspect, a device includes at least one computer memory that is not a transitory signal and that in turn includes instructions executable by at least one processor system to present an opt-in selection on a display configured to present computer games under control of a computer game console. The instructions are executable to, responsive to selection of the opt-in selection, respond to signals from at least one server system to generate video clips as help clips. The instructions also are executable to, responsive to no selection of the opt-in selection, not generate video clips as help clips and provide game play statistics to the server system.

The details of the present application, both as to its structure and operation, can be best understood in reference to the accompanying drawings, in which like reference numerals refer to like parts, and in which:

### BRIEF DESCRIPTION OF THE DRAWINGS

FIG. 1 is a block diagram of an example system in accordance with present principles;

FIG. 2 illustrates an example community game help architecture;

FIGS. 3 and 4 illustrate example screen shots for opting in to participate in community game help;

FIG. 5 illustrates example logic in example flow chart format for end user game consoles;

FIG. 6 illustrates example logic in example flow chart format for game server systems;

FIG. 7 illustrates example logic in example flow chart format for determining criteria for acceptable help clips;

FIG. 8 illustrates data flow consistent with FIG. 7;

FIG. 9 illustrates example logic in example flow chart format for collectible events; and

FIG. 10 illustrates an example screen shot with game help video clips.

### DETAILED DESCRIPTION

This disclosure relates generally to computer ecosystems including aspects of consumer electronics (CE) device networks such as but not limited to computer game networks. A system herein may include server and client components which may be connected over a network such that data may be exchanged between the client and server components. The client components may include one or more computing devices including game consoles such as Sony PlayStation® or a game console made by Microsoft or Nintendo or other manufacturer, extended reality (XR) headsets such as virtual reality (VR) headsets, augmented reality (AR) headsets, portable televisions (e.g., smart TVs, Internet-enabled TVs), portable computers such as laptops and tablet computers, and other mobile devices including smart phones and additional examples discussed below. These client devices may operate with a variety of operating environments. For example, some of the client computers may employ, as examples, Linux operating systems, operating systems from Microsoft, or a Unix operating system, or operating systems produced by Apple, Inc., or Google, or a Berkeley Software Distribution or Berkeley Standard Distribution (BSD) OS including descendants of BSD. These operating environments may be used to execute one or more browsing programs, such as a browser made by Microsoft or Google or Mozilla or other browser program that can access websites hosted by the Internet servers discussed below. Also, an operating environment according to present principles may be used to execute one or more computer game programs.

Servers and/or gateways may be used that may include one or more processors executing instructions that configure the servers to receive and transmit data over a network such as the Internet. Or a client and server can be connected over a local intranet or a virtual private network. A server or controller may be instantiated by a game console such as a Sony PlayStation®, a personal computer, etc.

Information may be exchanged over a network between the clients and servers. To this end and for security, servers and/or clients can include firewalls, load balancers, temporary storages, and proxies, and other network infrastructure for reliability and security. One or more servers may form an apparatus that implement methods of providing a secure community such as an online social website or gamer network to network members.

A processor may be a single- or multi-chip processor that can execute logic by means of various lines such as address lines, data lines, and control lines and registers and shift registers. A processor including a digital signal processor (DSP) may be an embodiment of circuitry. A processor system may include one or more processors.

Components included in one embodiment can be used in other embodiments in any appropriate combination. For example, any of the various components described herein and/or depicted in the Figures may be combined, interchanged, or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together.

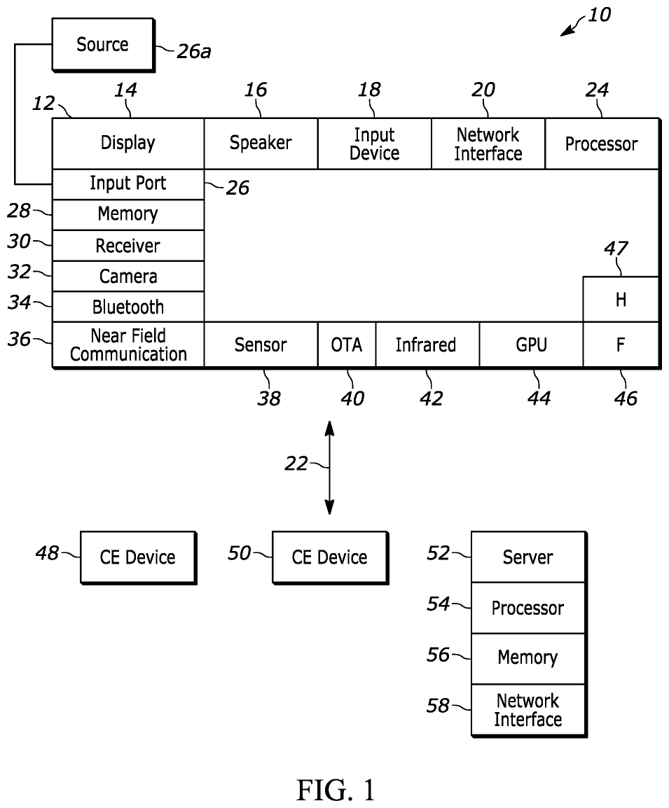

Referring now to FIG. 1, an example system 10 is shown, which may include one or more of the example devices mentioned above and described further below in accordance with present principles. The first of the example devices included in the system 10 is a consumer electronics (CE) device such as an audio video device (AVD) 12 such as but not limited to a theater display system which may be projector-based, or an Internet-enabled TV with a TV tuner (equivalently, set top box controlling a TV). The AVD 12 alternatively may also be a computerized Internet enabled (“smart”) telephone, a tablet computer, a notebook computer, a head-mounted device (HMD) and/or headset such as smart glasses or a VR headset, another wearable computerized device, a computerized Internet-enabled music player, computerized Internet-enabled headphones, a computerized Internet-enabled implantable device such as an implantable skin device, etc. Regardless, it is to be understood that the AVD 12 is configured to undertake present principles (e.g., communicate with other CE devices to undertake present principles, execute the logic described herein, and perform any other functions and/or operations described herein).

Accordingly, to undertake such principles the AVD 12 can be established by some, or all of the components shown. For example, the AVD 12 can include one or more touch-enabled displays 14 that may be implemented by a high definition or ultra-high definition “4K” or higher flat screen. The touch-enabled display(s) 14 may include, for example, a capacitive or resistive touch sensing layer with a grid of electrodes for touch sensing consistent with present principles.

The AVD 12 may also include one or more speakers 16 for outputting audio in accordance with present principles, and at least one additional input device 18 such as an audio receiver/microphone for entering audible commands to the AVD 12 to control the AVD 12. The example AVD 12 may also include one or more network interfaces 20 for communication over at least one network 22 such as the Internet, an WAN, an LAN, etc. under control of one or more processors 24. Thus, the interface 20 may be, without limitation, a Wi-Fi transceiver, which is an example of a wireless computer network interface, such as but not limited to a mesh network transceiver. It is to be understood that the processor 24 controls the AVD 12 to undertake present principles, including the other elements of the AVD 12 described herein such as controlling the display 14 to present images thereon and receiving input therefrom. Furthermore, note the network interface 20 may be a wired or wireless modem or router, or other appropriate interface such as a wireless telephony transceiver, or Wi-Fi transceiver as mentioned above, etc.

In addition to the foregoing, the AVD 12 may also include one or more input and/or output ports 26 such as a high-definition multimedia interface (HDMI) port or a universal serial bus (USB) port to physically connect to another CE device and/or a headphone port to connect headphones to the AVD 12 for presentation of audio from the AVD 12 to a user through the headphones. For example, the input port 26 may be connected via wire or wirelessly to a cable or satellite source 26a of audio video content. Thus, the source 26a may be a separate or integrated set top box, or a satellite receiver. Or the source 26a may be a game console or disk player containing content. The source 26a when implemented as a game console may include some or all of the components described below in relation to the CE device 48.

The AVD 12 may further include one or more computer memories/computer-readable storage media 28 such as disk-based or solid-state storage that are not transitory signals, in some cases embodied in the chassis of the AVD as standalone devices or as a personal video recording device (PVR) or video disk player either internal or external to the chassis of the AVD for playing back AV programs or as removable memory media or the below-described server. Also, in some embodiments, the AVD 12 can include a position or location receiver such as but not limited to a cellphone receiver, GPS receiver and/or altimeter 30 that is configured to receive geographic position information from a satellite or cellphone base station and provide the information to the processor 24 and/or determine an altitude at which the AVD 12 is disposed in conjunction with the processor 24.

Continuing the description of the AVD 12, in some embodiments the AVD 12 may include one or more cameras 32 that may be a thermal imaging camera, a digital camera such as a webcam, an IR sensor, an event-based sensor, and/or a camera integrated into the AVD 12 and controllable by the processor 24 to gather pictures/images and/or video in accordance with present principles. Also included on the AVD 12 may be a Bluetooth® transceiver 34 and other Near Field Communication (NFC) element 36 for communication with other devices using Bluetooth and/or NFC technology, respectively. An example NFC element can be a radio frequency identification (RFID) element.

Further still, the AVD 12 may include one or more auxiliary sensors 38 that provide input to the processor 24. For example, one or more of the auxiliary sensors 38 may include one or more pressure sensors forming a layer of the touch-enabled display 14 itself and may be, without limitation, piezoelectric pressure sensors, capacitive pressure sensors, piezoresistive strain gauges, optical pressure sensors, electromagnetic pressure sensors, etc. Other sensor examples include a pressure sensor, a motion sensor such as an accelerometer, gyroscope, cyclometer, or a magnetic sensor, an infrared (IR) sensor, an optical sensor, a speed and/or cadence sensor, an event-based sensor, a gesture sensor (e.g., for sensing gesture command). The sensor 38 thus may be implemented by one or more motion sensors, such as individual accelerometers, gyroscopes, and magnetometers and/or an inertial measurement unit (IMU) that typically includes a combination of accelerometers, gyroscopes, and magnetometers to determine the location and orientation of the AVD 12 in three dimension or by an event-based sensors such as event detection sensors (EDS). An EDS consistent with the present disclosure provides an output that indicates a change in light intensity sensed by at least one pixel of a light sensing array. For example, if the light sensed by a pixel is decreasing, the output of the EDS may be −1; if it is increasing, the output of the EDS may be a +1. No change in light intensity below a certain threshold may be indicated by an output binary signal of 0.

The AVD 12 may also include an over-the-air TV broadcast port 40 for receiving OTA TV broadcasts providing input to the processor 24. In addition to the foregoing, it is noted that the AVD 12 may also include an infrared (IR) transmitter and/or IR receiver and/or IR transceiver 42 such as an IR data association (IRDA) device. A battery (not shown) may be provided for powering the AVD 12, as may be a kinetic energy harvester that may turn kinetic energy into power to charge the battery and/or power the AVD 12. A graphics processing unit (GPU) 44 and field programmable gated array 46 also may be included. One or more haptics/vibration generators 47 may be provided for generating tactile signals that can be sensed by a person holding or in contact with the device. The haptics generators 47 may thus vibrate all or part of the AVD 12 using an electric motor connected to an off-center and/or off-balanced weight via the motor's rotatable shaft so that the shaft may rotate under control of the motor (which in turn may be controlled by a processor such as the processor 24) to create vibration of various frequencies and/or amplitudes as well as force simulations in various directions.

A light source such as a projector such as an infrared (IR) projector also may be included.

In addition to the AVD 12, the system 10 may include one or more other CE device types. In one example, a first CE device 48 may be a computer game console that can be used to send computer game audio and video to the AVD 12 via commands sent directly to the AVD 12 and/or through the below-described server while a second CE device 50 may include similar components as the first CE device 48. In the example shown, the second CE device 50 may be configured as a computer game controller manipulated by a player or a head-mounted display (HMD) worn by a player. The HMD may include a heads-up transparent or non-transparent display for respectively presenting AR/MR content or VR content (more generally, extended reality (XR) content). The HMD may be configured as a glasses-type display or as a bulkier VR-type display vended by computer game equipment manufacturers.

In the example shown, only two CE devices are shown, it being understood that fewer or greater devices may be used. A device herein may implement some or all of the components shown for the AVD 12. Any of the components shown in the following figures may incorporate some or all of the components shown in the case of the AVD 12.

Now in reference to the afore-mentioned at least one server 52, it includes at least one server processor 54, at least one tangible computer readable storage medium 56 such as disk-based or solid-state storage, and at least one network interface 58 that, under control of the server processor 54, allows for communication with the other illustrated devices over the network 22, and indeed may facilitate communication between servers and client devices in accordance with present principles. Note that the network interface 58 may be, e.g., a wired or wireless modem or router, Wi-Fi transceiver, or other appropriate interface such as, e.g., a wireless telephony transceiver.

Accordingly, in some embodiments the server 52 may be an Internet server or an entire server “farm” and may include and perform “cloud” functions such that the devices of the system 10 may access a “cloud” environment via the server 52 in example embodiments for, e.g., network gaming applications. Or the server 52 may be implemented by one or more game consoles or other computers in the same room as the other devices shown or nearby.

The components shown in the following figures may include some or all components shown in herein. Any user interfaces (UI) described herein may be consolidated and/or expanded, and UI elements may be mixed and matched between UIs.

Present principles may employ various machine learning models, including deep learning models. Machine learning models consistent with present principles may use various algorithms trained in ways that include supervised learning, unsupervised learning, semi-supervised learning, reinforcement learning, feature learning, self-learning, and other forms of learning. Examples of such algorithms, which can be implemented by computer circuitry, include one or more neural networks, such as a convolutional neural network (CNN), a recurrent neural network (RNN), and a type of RNN known as a long short-term memory (LSTM) network. Generative pre-trained transformers (GPTT) also may be used. Support vector machines (SVM) and Bayesian networks also may be considered to be examples of machine learning models. In addition to the types of networks set forth above, models herein may be implemented by classifiers.

As understood herein, performing machine learning may therefore involve accessing and then training a model on training data to enable the model to process further data to make inferences. An artificial neural network/artificial intelligence model trained through machine learning may thus include an input layer, an output layer, and multiple hidden layers in between that are configured and weighted to make inferences about an appropriate output.

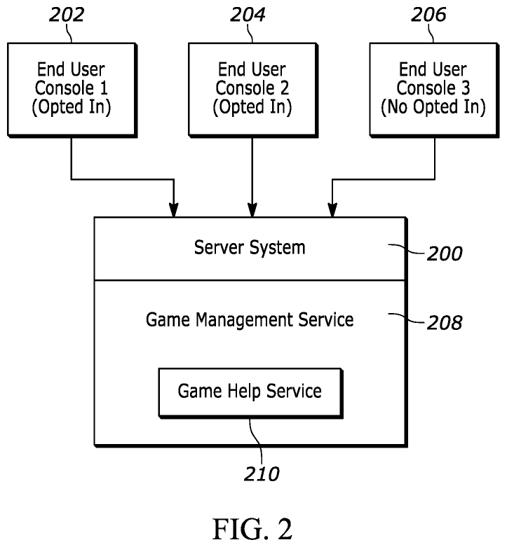

Refer now to FIG. 2 which illustrates a server system 200 for sourcing computer simulations such as computer or video games to end user consoles 202, 204, both of which have opted in to creating community help videos for games. The server system 200 also sources computer simulations to an end user console 206 that as not opted in to community help. Game statistics from all three consoles 202-206 may be used to select help videos consistent with disclosure herein, but only videos from opting-in consoles 202, 204 are candidates for being accepted for community help videos. It is to be understood that greater than three end user consoles can receive computer simulations from the server system 200.

As shown, the server system 200 may include a game management service 208 that in turn may include a game help service 210 for implementing present principles. The services 208, 210 may be implemented by processor systems. The server system 200 may communicate with end user consoles over a wired and/or wireless computer network such as the Internet.

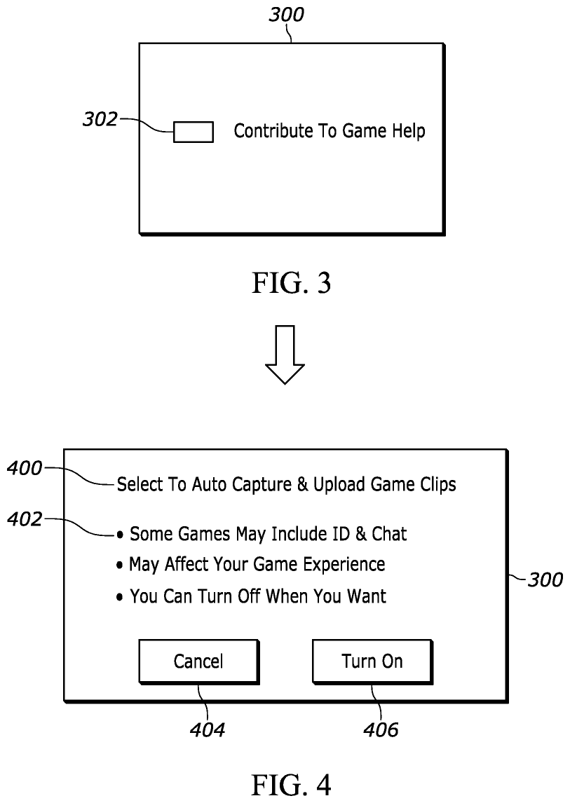

FIGS. 3 and 4 illustrate screen shots that may be presented on a display 300 receiving data from an end user console. As shown, a selector 302 may be selected from the user interface (UI) of FIG. 3 to invoke the UI of FIG. 4, which may include a prompt 400 to select to join community game help video generation. Advisories 402 also may be presented indicating that some games that may be candidates for help videos may contain information in the video such as identifiers of users, chat text, etc. The advisories 402 also may indicate that participating in community game help video generation might affect gameplay, and that the user may turn off helping with community help videos. Selectors 404, 406 may be provided to respectively opt out and opt in to participation in community game help video generation.

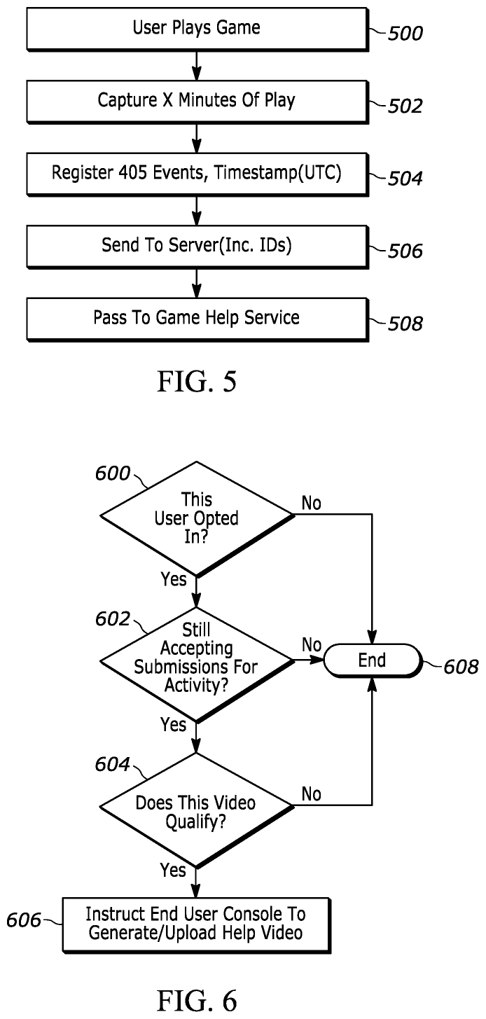

FIG. 5 illustrates example logic of end user consoles that opt in to participate in game help video generation. Commencing at state 500, a gamer plays a video game. Moving to state 502, “X” minutes of the game are captured automatically by the console, wherein “X” may be an integer or fraction thereof. Thus, as the gamer plays the game, a ring buffer may capture local video of last X minutes of gameplay.

Proceeding to state 504, the console registers uniform data system (UDS) events that occur in the game, and the ring buffer matches video segments to respective coordinated universal time (UTC) timestamps.

As discussed in greater detail below, in the event that the server system 200 determines that a new help video for the current activity in the game, the server system 200 instructs the console to generate an asset. In the background transparently to the gamer, the console uses the UDS timestamps to match to ring buffer timestamps so that a video asset (such as a video clip) is generated for the period indicated by the timestamps and at state 506 automatically uploads the asset to the game management service 208 shown in FIG. 2 along with an asset ID indicating the specific game being played, an activity ID indicating the game activity that is the subject of the asset, and a user ID. State 508 indicates that the game management service 208 passes the transcoded media to the game help service 210 along with the content delivery network (CDN) location, asset ID, activity ID, and user ID.

Note that in addition to the above IDs and other metadata, metadata associated with a candidate help clip may include game metadata such as weapons load out during the action captured by the clip, difficulty level of the game, the language of the user during game play, etc. In this way, subsequent users may be matched to a “best” help video for their circumstances.

If desired, after the console successfully uploads the video asset to the game management service, the console may delete the local copy of the video asset.

FIG. 6 illustrates logic of the server system 200. The logic may be performed before or after receiving information about a successful activity completion.

Commencing at state 600, it is determined, using the user ID, whether the gamer/user has opted-in to generate game help videos. Only users that have opted in to the community game help program can have their footage captured and uploaded for help video purposes. If the user has opted in, the logic moves to state 602 to determine whether the system is still accepting new submissions for this activity. To provide enough backup videos to ensure game help is available but not so many that help videos are generated in perpetuity, the number of qualified submissions of candidate game help video clips may be capped. Note that a further test may be that to be a successful candidate help clip, the generating player must have achieved the goal of the activity in the clip. Clips in which the player failed to achieve the goal may be discarded as help clips.

Furthermore, older help video clips may be periodically purged from the number of help videos maintained for a particular game and activity to account for subtle game aspects becoming known to players over time. Gamers using help video clips may assign ratings to the clips, such that lower rated help video clips may be purged. Expert review if clips also may be used to weed out less effective clips. Also, sentiment of gamers viewing help clips may be used to weed out clips that are associated with negative sentiments. Sentiment may be determined using machine learning based on facial expressions from camera images, voice intonation from microphone signals, etc.

If submissions are still being accepted, the logic moves to state 604 to determine whether the current video being considered qualifies as a game help video based on criteria, examples of which are discussed further below. Only if all three tests at states 600-604 are met (including additional tests such as whether the goal of the activity in the clip was achieved) does the logic in the example of FIG. 6 flow to state 606 at which the help service 210 instructs the console to generate and upload a help video, or equivalently designates the video asset under test as a help video for the particular game and activity based on the asset and activity IDs. If any of the tests fails the logic may end at state 608.

Accordingly, when game help videos come from the community of players who opt in, several videos typically will be made available for each leaf node (each activity in each game) to deal with potential moderation issues, player removal of gameplay videos, or other reasons a video may need to be removed from the help system. However, to avoid generating help videos in perpetuity, the number of help videos for a given in-game activity is capped as described above.

Moreover, to determine whether a candidate help video asset (clip) qualifies, candidates are selected on the basis of being representative of expected gameplay for a particular activity leaf node. Present principles recognize that selection should account for play time varying per game and per activity within a game, and that edge cases should be excluded. An example edge case is a player that is extremely good at the game (and thus may not provide help to the average player). Other edge cases include glitches, bugs, or game replays that use end-game loot to complete early activities with ease.

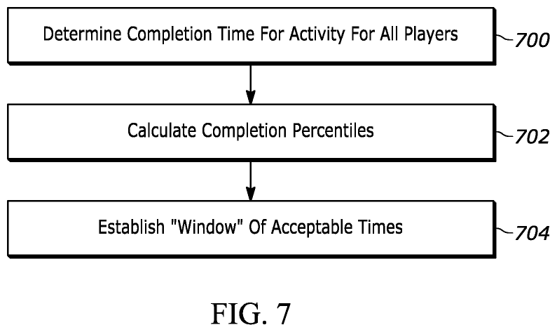

FIG. 7 illustrates an example technique for dealing with the issues above in selection of which videos to use for game help. State 700 indicates that the completion time for each activity from all players is considered, including for players who opted out of providing game help videos. State 702 indicates that activity completion percentiles may be computed on the fly, using as few data points as necessary, and based on the statistics from states 700 and 702, at state 704 a window of acceptable times may be established, within which a candidate game help video must be to be accepted as a system game help video.

If desired, once a candidate help video clip is accepted for inclusion into the clips for the relevant node, any generating user commentary in the clip as may have been picked up by a microphone may be removed from the clip. This may occur prospectively at the game console prior to uploading the clip or at the server after receiving the clip. To this end, machine learning may be used. A ML model may be trained on the audio of the segment of the game in question and remove unrecognized verbalizations or exclamations.

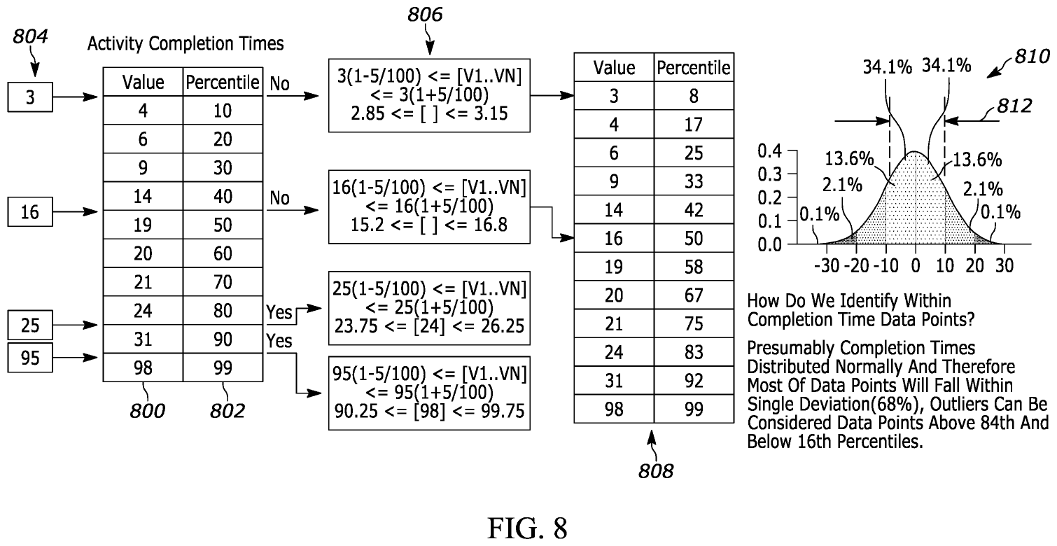

FIG. 8 illustrates the logic of state 702 in FIG. 7. A column 800 of activity completion time periods is registered with a column 802 of which percentile of game videos the completion time period applies to. Note that the numbers in the left-most column 804 in FIG. 8 represent time periods to complete the associated activities in the clips. As more clips are considered and placed into correct order on a percentile basis by the equations in the fourth column 806, a final list of completion time periods is established as shown once percentiles have stabilized from the entire community of players.

In any case, as shown in the curve 810 of FIG. 8, the distribution of completion time periods for an in-game activity is expected to be a normal distribution, so that a window 812 straddling the center of the curve is established to define the time period range a candidate help video must have for the respective activity and game to be found acceptable as a help video for the system, with outliers of the left and right tails of the curve 810 not being considered as representing acceptable completion time periods. The same technique of establishing a window around the middle portion of the distribution may be used for other types of distributions, e.g., Gaussian.

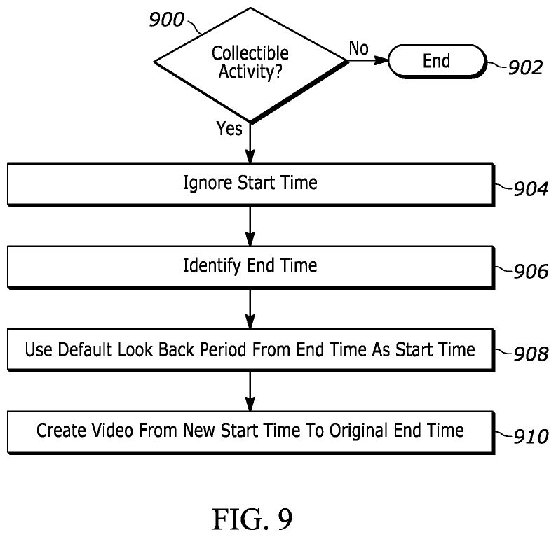

FIG. 9 illustrates the special case of collectible in-game activities. More specifically, certain types of activities represent the discovery of in-game items that can be found throughout the world but are often only there for the purpose of boosting gear, adding to the story's lore, or otherwise expanding on things to do in the game. Given that these activities are often available right from the start of the game, determining when players “started” these activities doesn't apply in the same way as it might to other types of activities. Rather, finding a collectible represents a specific moment in time.

Accordingly, at state 900 the logic implemented by the console and/or server system determines whether the activity of the game under test is a collectible by checking whether a “Is Collectible” flag is set to true in UDS. If not the logic ends at state 902 but if the activity is a collectible the logic moves to state 904 to ignore the UDS activity start time provided by the game and identify the activity end time at state 906. Moving to state 908, the logic uses a default look back period such as thirty seconds from the end time identified at state 906 to establish the start time of the video clip (in this example, always thirty seconds before the end time). State 910 indicates that a discrete video is created from the calculated start time that ends with the player successfully finding the in-game item but does so in an easily digestible manner for a help consumer.

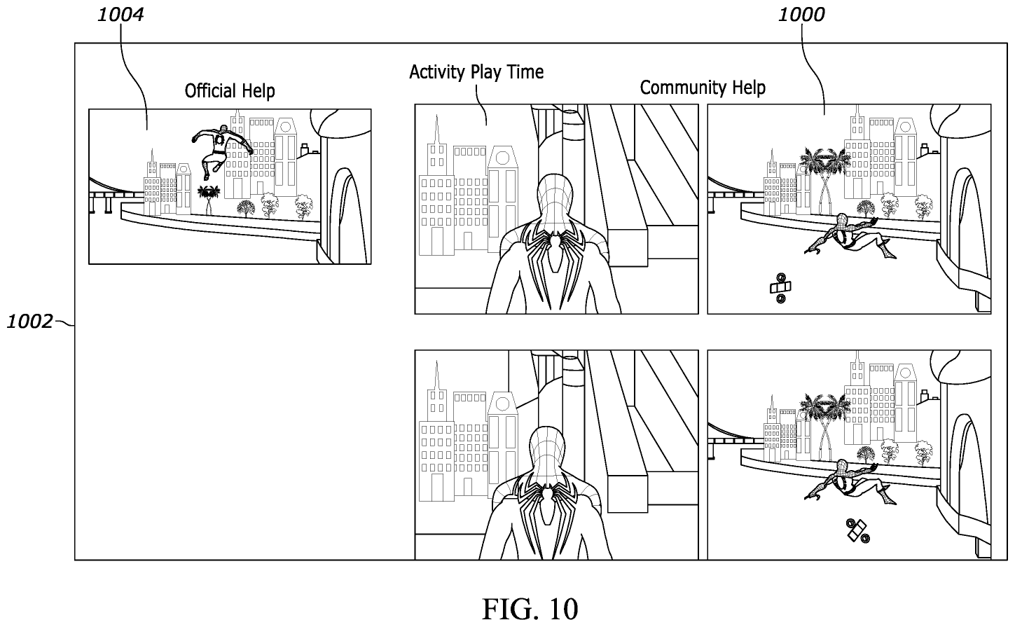

FIG. 10 illustrates a screen shot showing four community generated help video thumbnails 1000 that may be selected to cause the underlying help video to be played. A separate window 1002 may show the game in its current play state. If desired, a publisher help video 1004 also may be provided for selection.

Note that the help clips presented to the user may be ordered according to a best match for that player as determined by the game state metadata of the clips (weapons load out, game level, etc.) best matching the current corresponding game state of the player requesting help.

Accordingly, it may now be appreciated that an end user game console receives a set of instructions from the server system to generate a video from the ring buffer. The video generation request includes additional metadata required to display the video to players in Game Help including the source player userId, associated activityId, and video metadata like startTime and endTime. In turn, the console is also able to manage requests and return error cases when a requested video is not possible or not desired.

This infrastructure may also be applied to a number of cases in which a server makes video capture requests based on the unique cases of a particular feature.

At launch, the console and local services can handle the following:
Handling of new video requests and the generation of video files that match start/end UTC timestamps
Upload video file in the background and manage temporary storage of asset
Delete the video asset upon successful upload completion
Manage error cases and respond to the server with a rejection
   Typical cases include, but are not limited to: not enough hard drive space, requested video timestamps are not available on the ring buffer, too many concurrent requests, player microphone or webcam enabled during capture.

The help clips also may be used to recover from crashes. A generating player, for instance, may report a crash to the server and can receive back the help video generated by that player corresponding to the period of or just prior to the crash.

While the particular embodiments are herein shown and described in detail, it is to be understood that the subject matter which is encompassed by the present invention is limited only by the claims.

What is claimed is:

1. A method comprising:
determining that respective plural signals from respective plural computer game consoles indicate respective opt-ins to upload game videos for generating game help;
responsive to the opt-ins, determining whether new help submissions are still being accepted for a first computer game activity;
responsive to new help submissions still being accepted for the first computer game activity, determining, for each of respective video clips pertaining to the first computer game activity and uploaded from the respective computer game consoles, whether the video clip qualifies as a help clip based at least in part on at least one time period associated with the video clip; and
downloading at least one of the respective video clips pertaining to the first computer game activity and determined to qualify as a help clip to at least one computer game console other than the plural computer game consoles.

2. The method of claim 1, wherein the respective video clips comprise metadata associating respective times with respective game events.

3. The method of claim 2, wherein the metadata comprises an identification of a game associated with the video clip and an identification of an activity captured by the video clip.

4. The method of claim 1, comprising determining whether a video clip qualifies as a help clip at least in part by determining whether a time period to complete a first computer game activity in the video clip has a relationship to play time periods from a community of players.

5. The method of claim 4, wherein determining whether a time period to complete the first computer game activity in the video clip has a relationship to play time periods from a community of players comprises:
determining completion time periods for the first computer game activity from plural players;
determining completion percentiles using the completion time periods; and
determining that a video clip qualifies as a help clip based on the time period to complete the first computer game activity in the video clip is within a window of completion time periods.

6. The method of claim 1, wherein determining whether new help submissions are still being accepted for the first computer game activity comprises determining whether a predetermined maximum number of help clips are identified for the first game activity.

7. The method of claim 4, wherein the first video game activity comprises discovering an in-game item, and the method comprises:
identifying an end time based on when the item was discovered;
identifying a start time using a default look back period from the end time; and
generating the video clip as a help clip using video from the start time to the end time.

8. A processor system configured to:
receive at least first and second video clips from respective first and second end user computer game consoles, each video clip representing a first in-game activity for a first computer game; and
provide the first and second video clips to at least a third end user computer game console as help videos.

9. The processor system of claim 8, wherein the processor system is configured to:
determine that respective plural signals from the respective first and second end user computer game consoles indicate respective opt-ins to upload game videos for generating game help;
responsive to the opt-ins, determine whether new help submissions are still being accepted for the first in-game activity;
responsive to new help submissions still being accepted for the first in-game activity, determine, for each of respective video clips pertaining to the first in-game activity and uploaded from the respective first and second end user computer game consoles, whether the video clip qualifies as a help clip based at least in part on at least one time period associated with the video clip; and
provide, as help videos, video clips pertaining to the first in-game activity and determined to qualify as a help clip to at least the third end user computer game console.

10. The processor system of claim 8, wherein the respective video clips comprise metadata associating respective times with respective game events.

11. The processor system of claim 10, wherein the metadata comprises an identification of a game associated with the video clip and an identification of an activity captured by the video clip.

12. The processor system of claim 9, wherein the processor system is configured to:
determining whether a video clip qualifies as a help clip at least in part by determining whether a time period to complete a first computer game activity in the video clip has a relationship to play time periods from a community of players.

13. The processor system of claim 12, wherein the processor system is configured to:
determine whether a time period to complete the first computer game activity in the video clip has a relationship to play time periods from a community of players comprises:
determining completion time periods for the first computer game activity from plural players;
determining completion percentiles using the completion time periods; and
determining that a video clip qualifies as a help clip based on the time period to complete the first computer game activity in the video clip is within a window of completion time periods.

14. The processor system of claim 8, wherein the processor system is configured to:
determine whether new help submissions are still being accepted for the first in-game activity by determining whether a predetermined maximum number of help clips are identified for the first in-game activity.

15. The processor system of claim 8, wherein the first in-game activity comprises discovering an in-game item, and the processor system is configured to:
identify an end time based on when the item was discovered;
identify a start time using a default look back period from the end time; and
generate a video clip as a help clip using video from the start time to the end time.

16. A device comprising:
at least one computer memory that is not a transitory signal and that includes instructions executable by at least one processor system to:
present an opt-in selection on a display configured to present computer games under control of a computer game console;
responsive to selection of the opt-in selection, respond to signals from at least one server system to generate video clips as help clips; and
responsive to no selection of the opt-in selection, not generate video clips as help clips and provide game play statistics to the server system.

17. The device of claim 16, wherein the instructions are executable to:
as a computer game is played, capture at least a portion of the game automatically using a ring buffer; and
register uniform data system (UDS) events that occur in the game.

18. The device of claim 17, wherein the instructions are executable to:
cause the ring buffer to match video segments to respective coordinated universal time (UTC) timestamps; and
use the timestamps to generate a video clip for a game period indicated by the timestamps.

19. The device of claim 18, wherein the instructions are executable to:
automatically upload the video clip to a server system along with an asset ID indicating a game being played, an activity ID indicating a game activity that is the subject of the video clip, and a user ID.

20. The device of claim 19, wherein the instructions are executable to:
after uploading the video clip, delete a local copy of the video clip.
